(19) United States
(12) Patent Application Publication
(10) Pub. No.: US 2009/0159100 A1
(43) Pub. Date: Jun. 25, 2009

(54) TWO-PIECE MAGNETICALLY COUPLED SUBSTRATE ROLLER USED IN MEGASONIC CLEANING PROCESS

(75) Inventors: Christopher R. Frey, McKinney, TX (US); Tim L. Robinson, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/343,808

(22) Filed: Dec. 24, 2008

Related U.S. Application Data
(60) Provisional application No. 61/016,544, filed on Dec. 24, 2007.

(51) Int. Cl. B08B 7/04; F16C 13/00; B23P 11/00; B23P 19/04

(52) U.S. Cl. 134/33; 492/15; 29/402.08

(57) ABSTRACT

Mechanisms which rotate semiconductor substrates while immersed in wet chemicals are often complex due to a need to prevent leakage of the chemicals. Wear of the mechanisms necessitates replacement, entailing significant maintenance costs. A two-part semiconductor substrate roller is disclosed which consists of a rotary power coupler and an inexpensive replaceable roller component which attaches to the rotary power coupler in a simple manner. An external rotary power source turns the rotary power coupler through a mechanism that prevents leakage of the wet chemicals from the processing equipment. The replaceable roller component may be attached to the rotary power coupler by any of several mechanisms. The cost of the replaceable roller component is less than 10 percent of the cost of the rotary power coupler. A method of replacing the replaceable roller component and a method of processing semiconductor substrates using the instant invention are also disclosed.

### FIELD OF THE INVENTION

This invention relates to the field of chemical processing equipment. More particularly, this invention relates to rotary drive mechanisms for semiconductor substrates in wet processing equipment.

### BACKGROUND OF THE INVENTION

Semiconductor substrates are fabricated with a multitude of process steps, including operations in which the semiconductor substrates are immersed in wet chemicals, typically for etching and cleaning purposes. To attain more uniformity of etching and cleaning across the semiconductor substrates, it is common practice to rotate the semiconductor substrates while they are immersed. Rotation of the semiconductor substrates is typically accomplished by rotating drive elements in frictional contact with the edge of the semiconductor substrates. Because the semiconductor substrates are typically totally immersed in the wet chemicals during the etching and cleaning processes, the rotating drive elements are necessarily in contact with the wet chemicals. The wet chemicals used are often corrosive or otherwise hazardous, and must be contained within the processing equipment for safety and environmental reasons. Applying rotary power to the rotating drive elements while minimizing leakage of the wet chemicals has been accomplished in various ways, including magnetically coupling a rotating drive element to a rotating power shaft through a sealed partition that prevents leakage of the wet chemicals. Mechanisms which successfully apply rotary power to the rotating drive element while preventing wet chemical leakage utilize complex designs for the rotating drive elements, in that the rotating drive element must perform both a semiconductor substrate rotating function and a rotary power coupling function. The rotating drive element is subject to wear at the points of contact with the semiconductor substrates. Replacement of the rotating drive element thus entails excess expense due to the cost of the rotary power coupling mechanism included in each replacement.

### SUMMARY OF THE INVENTION

This Summary is provided to comply with 37 C.F.R. §1.73, requiring a summary of the invention briefly indicating the nature and substance of the invention. It is submitted with the understanding that it will not be used to interpret or limit the scope or meaning of the claims.

The instant invention provides a two-part semiconductor substrate roller for use in wet chemical processing equipment for rotating semiconductor substrates while immersed in wet chemicals. The two-part semiconductor substrate roller consists of a rotary power coupler and an inexpensive replaceable roller component which attaches to the rotary power coupler in a simple manner that does not require the use of tools. An external rotary power source turns the rotary power coupler through a mechanism that prevents leakage of the wet chemicals from the processing equipment. The replaceable roller component may be attached to the rotary power coupler by any of several mechanisms, including threaded studs in tapped holes, spring detents in indented holes, magnetic force, static friction, adhesives or hook-and-loop fasteners. The external rotary power source may be coupled to the rotary power coupler by magnetic, hydraulic or mechanical mechanisms. In a preferred embodiment, the cost of the replaceable roller component is less than 10 percent of the cost of the rotary power coupler. A method of replacing the replaceable roller component and a method of processing semiconductor substrates using the instant invention are also disclosed.

### DESCRIPTION OF THE VIEWS OF THE DRAWING

FIG. 1 is a perspective illustration of a wet chemical semiconductor substrate processing apparatus utilizing the instant invention.

FIG. 2 depicts a common rotary power coupling configuration for a two-part semiconductor substrate roller embodying the instant invention.

FIG. 3A through FIG. 3D depict replacement of a first replaceable roller component with a second replaceable roller component.

FIG. 4A through FIG. 4F depict various embodiments of the attaching mechanism for connecting the replaceable roller component with the rotary power coupler.

FIG. 5A and FIG. 5B depict other embodiments for applying rotary power to the two-part semiconductor substrate roller.

### DETAILED DESCRIPTION

The present invention is described with reference to the attached figures, wherein like reference numerals are used throughout the figures to designate similar or equivalent elements. The figures are not drawn to scale and they are provided merely to illustrate the invention. Several aspects of the invention are described below with reference to example applications for illustration. It should be understood that numerous specific details, relationships, and methods are set forth to provide a full understanding of the invention. One skilled in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The need for a rotating drive element to rotate semiconductor substrates in wet chemical processing equipment with lower operating costs is met by the instant invention of a two-part semiconductor substrate roller consisting of a rotary power coupler and an inexpensive replaceable roller component which attaches to the rotary power coupler in a simple manner.

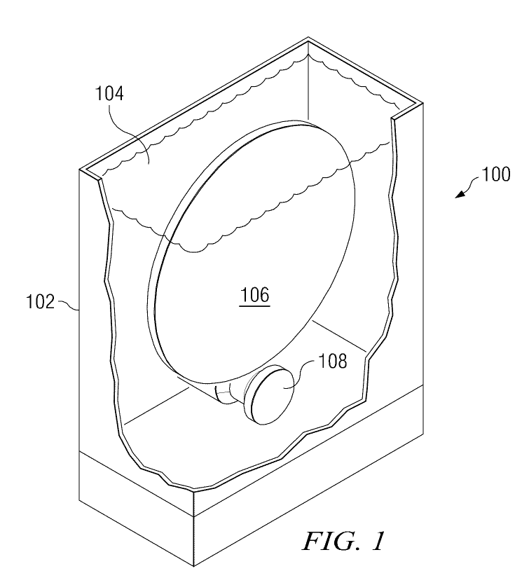

FIG. 1 is a perspective illustration of a wet chemical semiconductor substrate processing apparatus (100) utilizing the instant invention. Apparatus (100) includes a tank (102), shown in cutaway for clarity, containing wet chemicals (104). An optional pump, heater and/or cooler, ultrasonic transducer, etc., for the wet chemicals is not shown, for clarity. A semiconductor substrate (106) is immersed in the wet chemicals (104), and is rotated by a two-part semiconductor substrate roller (108) embodying the instant invention.

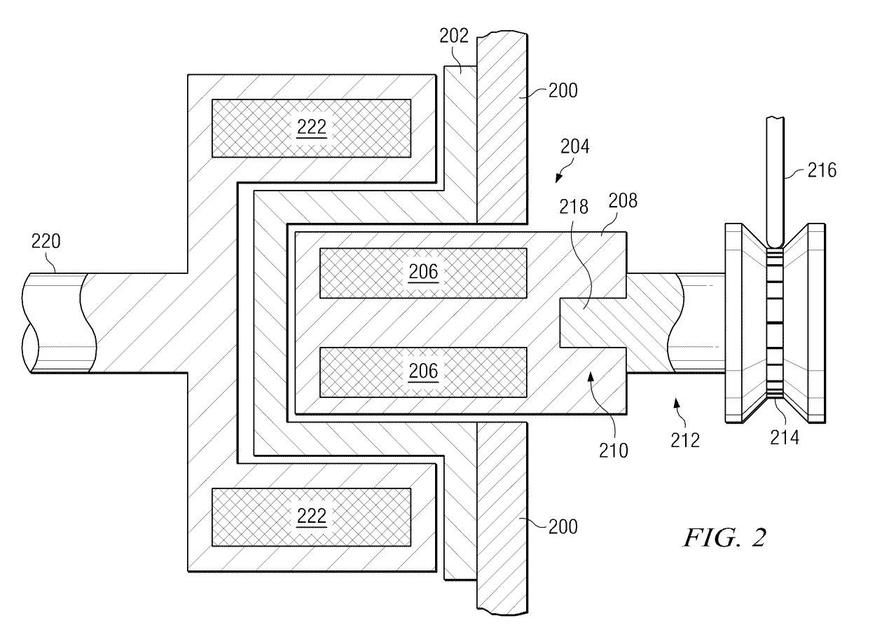

FIG. 2 depicts a common rotary power coupling configuration for a two-part semiconductor substrate roller embodying the instant invention. A section of a tank wall (200), typically fabricated from polypropylene or other material that does not significantly react with the wet chemicals contained by the tank, is attached to a cylindrical pocket element (202), also typically fabricated from polypropylene or other material that does not significantly react with the wet chemicals contained by the tank, in a manner that prevents leakage of the wet chemicals in the tank. A rotary power coupler (204), which includes slave magnets (206) sealed in a cylindrical bearing element (208) made of PEEK (poly-ether-ether-ketone), PTFE (poly-tetra-fluoro-ethylene), HDPE (high density polyethylene), polypropylene, or other material that is resistant to degradation by the wet chemicals in the tank and which can rotate in the cylindrical pocket element (202) with minimal friction, is positioned in the cylindrical pocket element (202). A first attaching element (210) is formed in one or both ends of the cylindrical bearing element (208) which attaches to a replaceable roller component (212). The replaceable roller component (212) includes a substrate drive wheel (214) which contacts a semiconductor substrate (216) to be rotated, and a second attaching element (218) which mates with the first attaching element (210) to provide a mechanically stable joint. The replaceable roller component (212) may be formed of the same material as the cylindrical bearing element (208) or a different material. Furthermore, the replaceable roller component (212) may be formed from more than one material to optimize the functions of attaching to the rotary power coupler (204) and driving the semiconductor substrate (216). Rotary power is transferred to the rotary power coupler (204) by a rotating power shaft (220), which is attached to drive magnets (222). In operation, rotation of the drive magnets (222) causes slave magnets (206) to rotate, which turns the rotary power coupler (204), which in turn rotates the replaceable roller component (212). Friction between the semiconductor substrate drive wheel (214) and the semiconductor substrate (216) causes the semiconductor substrate (216) to rotate, as desired.

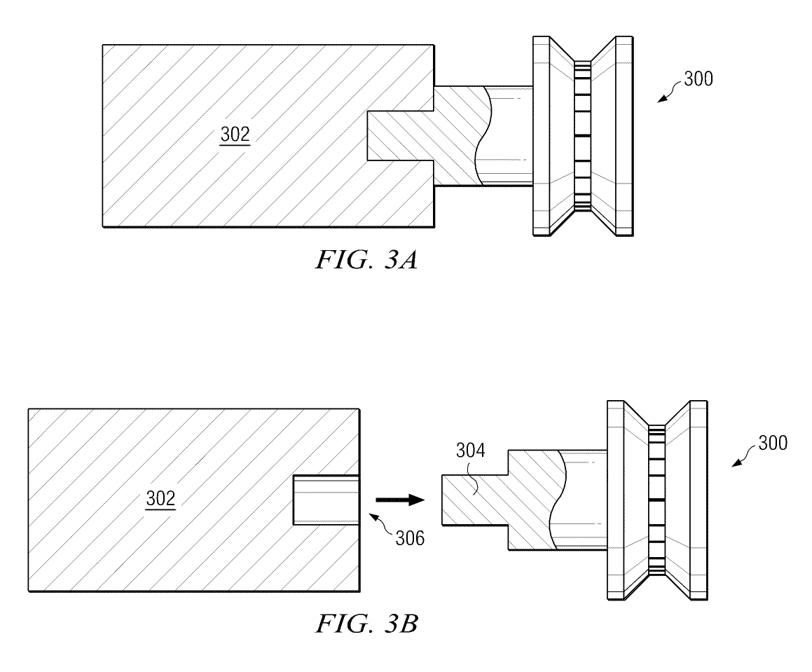

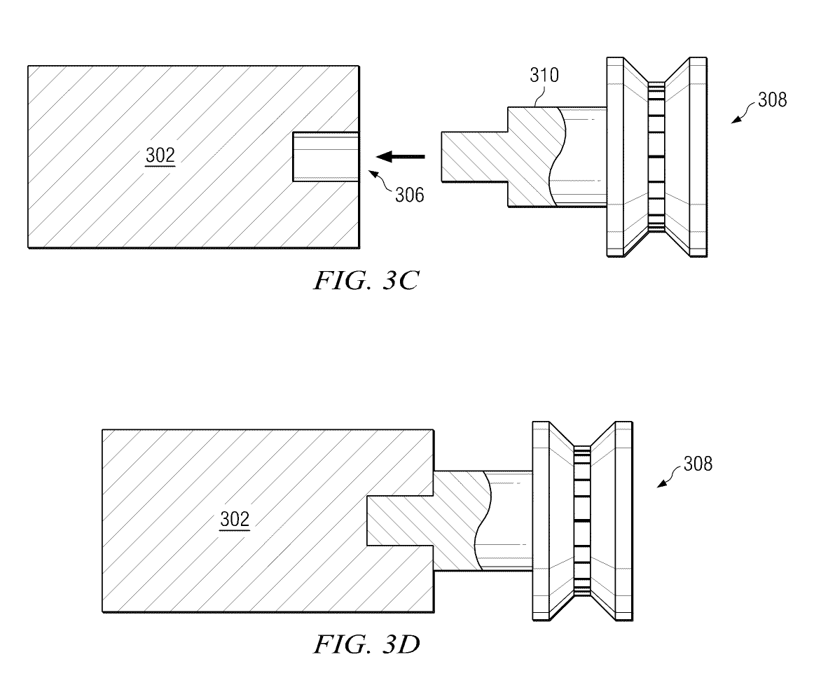

Referring to FIG. 3A through FIG. 3D, replacement of a first replaceable roller component with a second replaceable roller component is accomplished by starting with the first replaceable roller component (300) attached to a rotary power coupler (302) as depicted in FIG. 3A, detaching a first instance of the second attaching element (304) from the first attaching element (306) in the rotary power coupler (306) as depicted in FIG. 3B, providing a second replaceable roller component (308) and attaching it to the rotary power coupler (302) by attaching a second instance of the second attaching element (310) in the second replaceable roller component (308) to the first attaching element (306) in the rotary power coupler (302) as depicted in FIG. 3C, which results in the rotary power coupler (302) attached to the second replaceable roller component (308), as depicted in FIG. 3D. The first and second attaching elements (304, 306, 310) are configured to be detached and attached by hand, or possibly by a robotic manipulator, in a simple manner that minimizes or eliminates a requirement for tools such as wrenches, screwdrivers, pliers, etc. This is advantageous because it reduces the cost of manufacturing associated with the wet processing equipment by reducing or eliminating investment costs for tools needed for drive element replacement. Furthermore, a unit cost of the replaceable roller component is significantly less than a unit cost of an integrated drive element and rotary power coupler. In a preferred embodiment, the unit cost of the replaceable roller component is less than 10 percent of the unit cost of the rotary power coupler. This is advantageous because it further reduces the cost of manufacturing associated with the wet processing equipment by reducing the maintenance costs of the wet processing equipment.

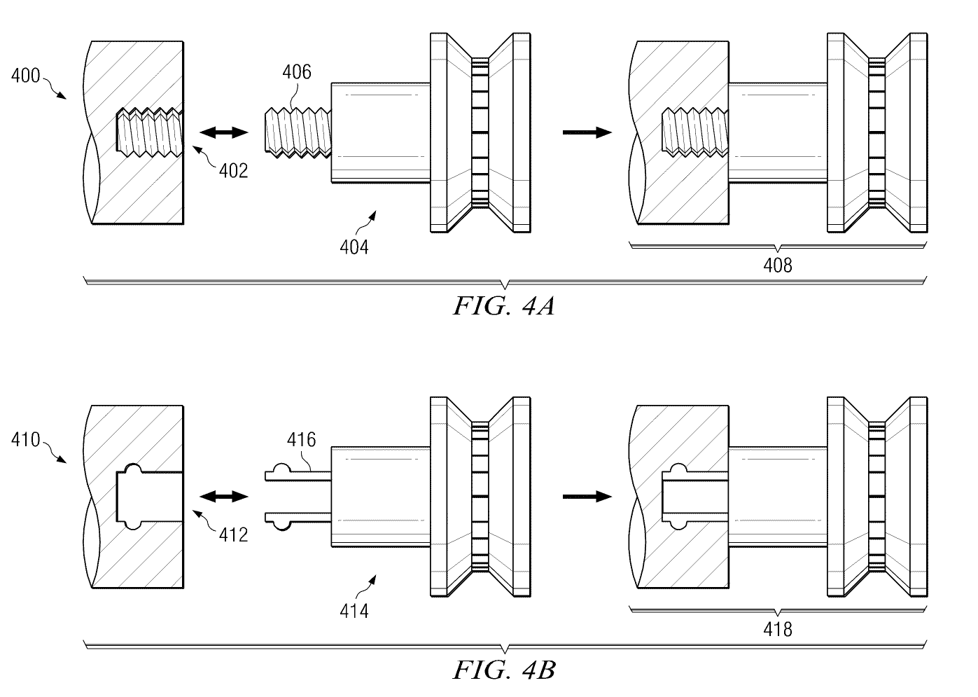

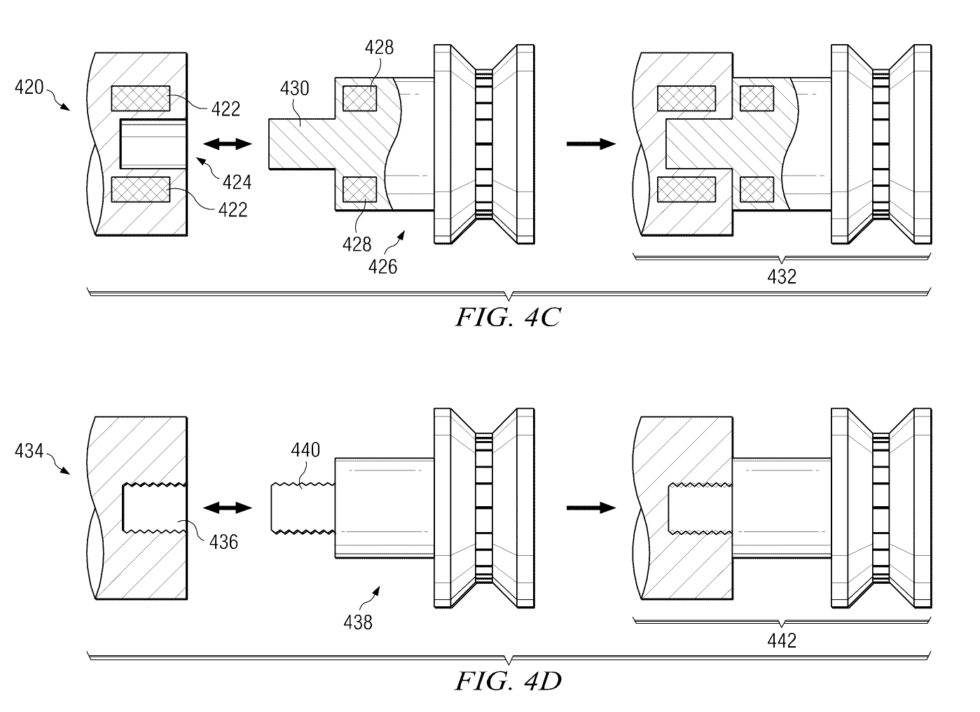

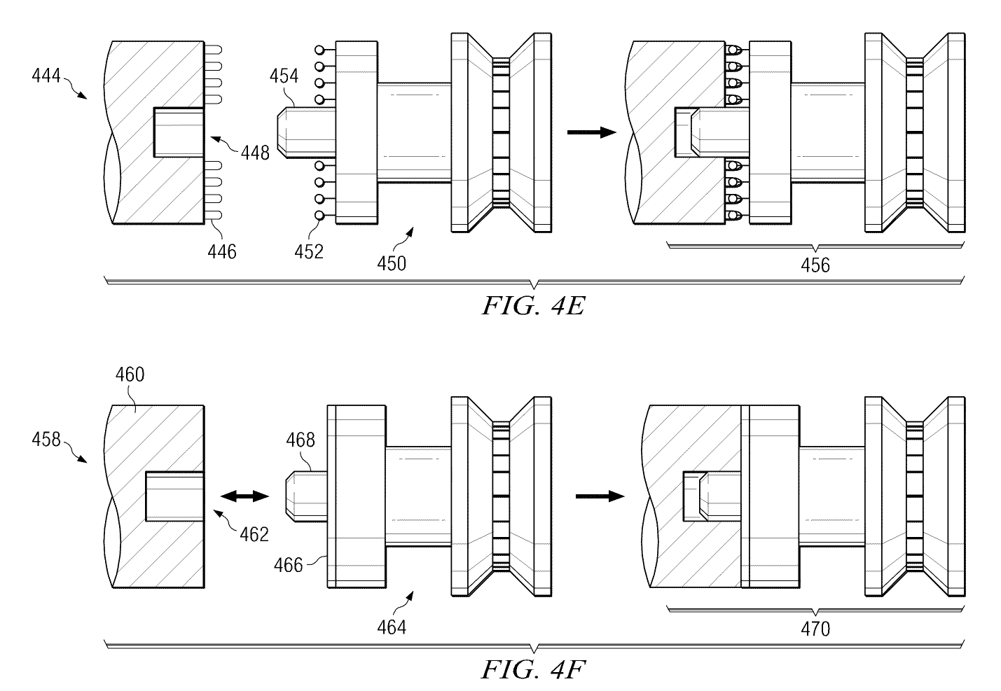

FIG. 4A through FIG. 4F depict embodiments of the attaching mechanisms for connecting the replaceable roller component with the rotary power coupler. Referring to FIG. 4A, a first instance of a rotary power coupler (400) includes a first instance of a first attaching element (402) configured as a threaded hole. A first instance of a replaceable roller component (404) includes a first instance of a second attaching element (406) configured as a threaded stud. The first instance of a replaceable roller component (404) is attached to the first instance of a rotary power coupler (400) by screwing the threaded stud (406) into the threaded hole (402), to produce a first instance of a two-part semiconductor substrate roller (408).

Referring to FIG. 4B, a second instance of a rotary power coupler (410) includes a second instance of a first attaching element (412) configured as an indented hole. A second instance of a replaceable roller component (414) includes a second instance of a second attaching element (416) configured as spring levers with detents. The second instance of a replaceable roller component (414) is attached to the second instance of a rotary power coupler (410) by inserting the spring levers (416) into the indented hole (412), to produce a second instance of a two-part semiconductor substrate roller (418).

Referring to FIG. 4C, a third instance of a rotary power coupler (420) includes a third instance of a first attaching element (422) configured as a first set of magnets with an optional alignment hole (424). A third instance of a replaceable roller component (426) includes a third instance of a third attaching element (428) configured as a second set of magnets with an optional alignment stud (430). The third instance of a replaceable roller component (426) is attached to the third instance of a rotary power coupler (422) by bringing the second set of magnets (428) into axially aligned proximity with the first set of magnets (422) and inserting optional alignment stud (430) into optional alignment hole (424), if present, to produce a third instance of a two-part semiconductor substrate roller (432).

Referring to FIG. 4D, a fourth instance of a rotary power coupler (434) includes a fourth instance of a first attaching element (436) configured as hole lined with a frictional surface. A fourth instance of a replaceable roller component (438) includes a fourth instance of a fourth attaching element (440) configured a stud with a frictional surface. The fourth instance of a replaceable roller component (438) is attached to the fourth instance of a rotary power coupler (434) by inserting the stud with the frictional surface (440) into the hole lined with the frictional surface (436), to produce a fourth instance of a two-part semiconductor substrate roller (442).

Referring to FIG. 4E, a fifth instance of a rotary power coupler (444) includes a fifth instance of a first attaching element (446) configured as a first surface of a hook-and-loop mechanism, commonly called by the trademarked name Velcro™, with an optional alignment hole (448). A fifth instance of a replaceable roller component (450) includes a fifth instance of a fifth attaching element (452) configured as a second surface of the hook-and-loop mechanism with an optional alignment stud (454). The fifth instance of a replaceable roller component (450) is attached to the fifth instance of a rotary power coupler (444) by pressing the second surface of the hook-and-loop mechanism (452) against the first surface of the hook-and-loop mechanism (446) and inserting optional alignment stud (454) into optional alignment hole (448), if present, to produce a fifth instance of a two-part semiconductor substrate roller (456).

Referring to FIG. 4F, a sixth instance of a rotary power coupler (458) includes a sixth instance of a first attaching element (460) configured as an adhesive mounting surface, with an optional alignment hole (462). A sixth instance of a replaceable roller component (464) includes a sixth instance of a sixth attaching element (466) configured as an adhesive element with an optional alignment stud (468). The sixth instance of a replaceable roller component (464) is attached to the sixth instance of a rotary power coupler (458) by pressing the adhesive element (466) against the adhesive mounting surface (460) and inserting optional alignment stud (468) into optional alignment hole (462), if present, to produce a sixth instance of a two-part semiconductor substrate roller (470).

It is within the scope of the instant invention for a replaceable roller component to be attached to a rotary power coupler by other mechanisms than those discussed above. Those involved with maintaining wet chemical processing equipment will comprehend that the advantages of a replaceable roller component that can be replaced at low cost, with quick cycle time and low investment will be accrued irrespective of the details of the attaching mechanism.

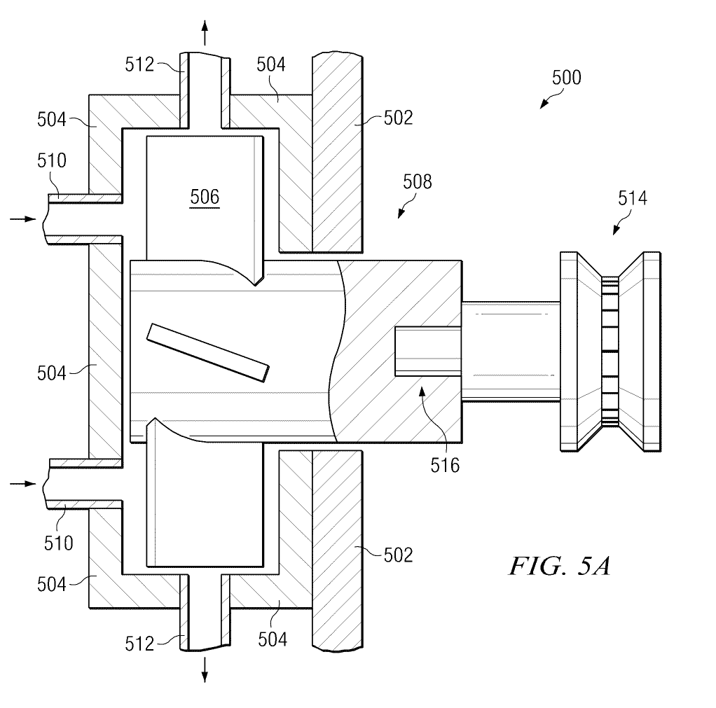

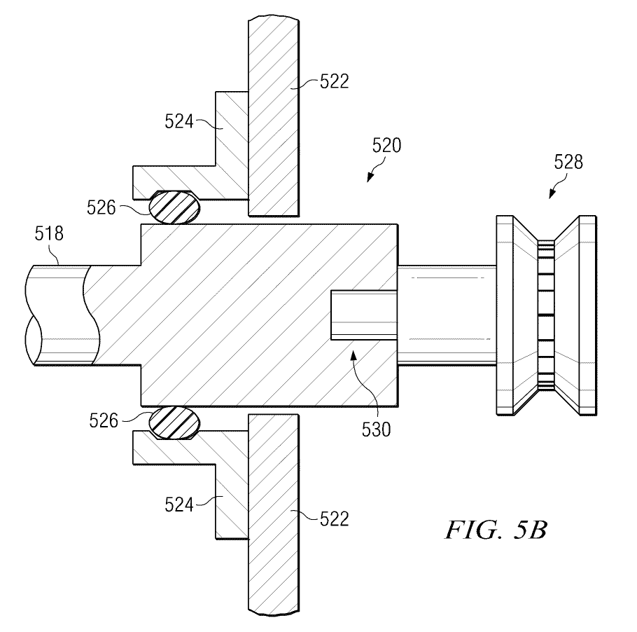

In other embodiments of the instant invention, rotary power may be imparted to the two-part semiconductor substrate roller by other means than a magnetically coupled drive shaft. FIG. 5A depicts an embodiment in which rotary power is applied by a hydraulic mechanism (500). A wall (502) of a tank containing wet chemicals has a hydraulic pump housing (504) attached in a manner that prevents wet chemicals from leaking. An impeller (506) or other hydraulic mechanism, is contained in the housing (504) and is connected to a rotary power coupler (508). Fluid, which may be the wet chemicals used in the tank, is introduced into the hydraulic mechanism (500) through input ports (510), causing the impeller (506) or other hydraulic mechanism and the rotary power coupler (508) to rotate, and exits from the hydraulic mechanism (500) through output ports (512). A replaceable roller component (514) is attached to the rotary power coupler (508) by an attachment mechanism (516) that permits simple, rapid replacement of the drive element, as discussed above.

FIG. 5B depicts another embodiment in which rotary power is applied by direct connection between a rotating shaft (518) and a rotary power coupler (520). In the instant embodiment, a wall (522) of a tank containing wet chemicals has a rotary seal ring (524) attached in a manner that prevents wet chemicals from leaking. A rotary seal (526), commonly formed of polypropylene, PTFE, HDPE, or other material that maintains a leaktight seal and is not degraded by the wet chemicals, prevents leakage between the rotary seal ring (524) and the rotating shaft (518). Rotation of the shaft (518) causes the rotary power coupler (520) to rotate. A replaceable roller component (528) is attached to the rotary power coupler (520) by an attachment mechanism (530) that permits simple, rapid replacement of the drive element, as discussed above.

It is within the scope of the instant invention for rotary power to be applied to a rotary power coupler by other mechanisms than those discussed above. Those involved with maintaining wet chemical processing equipment will comprehend that the advantages of a replaceable roller component that can be replaced at low cost, with quick cycle time and low investment will be accrued irrespective of the details of the rotary power mechanism.

Those skilled in the art to which the invention relates will appreciate that the described implementations are merely illustrative example embodiments, and that there are many other embodiments and variations of embodiments that can be implemented within the scope of the claimed invention.

What is claimed is:

1. A two-part semiconductor substrate roller for rotating semiconductor substrates comprising:
a rotary power coupler; and
a replaceable roller component that attaches to said rotary power coupler in a manner that permits detachment without the use of tools.

2. The two-part semiconductor substrate roller of claim 1, in which a unit cost of said replaceable roller component is less than 10 percent of a unit cost of said rotary power coupler.

3. The two-part semiconductor substrate roller of claim 2, in which:
said rotary power coupler further comprises a threaded hole;
said replaceable roller component further comprises a threaded stud;
said replaceable roller component is attached to said rotary power coupler by screwing said threaded stud into said threaded hole; and
said replaceable roller component is detached from said rotary power coupler by unscrewing said threaded stud from said threaded hole.

4. The two-part semiconductor substrate roller of claim 2, in which:
said rotary power coupler further comprises an indented hole;
said replaceable roller component further comprises one or more spring levers with detents;
said replaceable roller component is attached to said rotary power coupler by inserting said spring levers with detents into said indented hole; and
said replaceable roller component is detached from said rotary power coupler by extracting said spring levers with detents from said indented hole.

5. The two-part semiconductor substrate roller of claim 2, in which:
said rotary power coupler further comprises a first set of magnets;
said replaceable roller component further comprises a second set of magnets;
said replaceable roller component is attached to said rotary power coupler by placing said first set of magnets and said second set of magnets in close proximity while axially aligned so that said replaceable roller component is held to said rotary power coupler by magnetic force; and
said replaceable roller component is detached from said rotary power coupler by pulling said replaceable roller component and said rotary power coupler apart with enough force to overcome said magnetic force.

6. The two-part semiconductor substrate roller of claim 2, in which:
said rotary power coupler further comprises a hole lined with a frictional surface;
said replaceable roller component further comprises a stud with a frictional surface;
said replaceable roller component is attached to said rotary power coupler by inserting said stud into said hole; and
said replaceable roller component is detached from said rotary power coupler by extracting said stud from said hole.

7. The two-part semiconductor substrate roller of claim 2, in which:
said replaceable roller component is comprised of poly-ether-ether-ketone (PEEK).

8. The two-part semiconductor substrate roller of claim 2, in which rotary power is applied to said rotary power coupler by a rotating power shaft through a magnetic coupling mechanism which prevents fluid leakage between regions adjacent to said rotary power coupler and regions adjacent to said rotating power shaft.

9. The two-part semiconductor substrate roller of claim 2, in which rotary power is applied to said rotary power coupler by a hydraulic pump.

10. The two-part semiconductor substrate roller of claim 2, in which rotary power is applied to said rotary power coupler by a rotating power shaft through a rotary seal mechanism which prevents fluid leakage between regions adjacent to said rotary power coupler and regions adjacent to said rotating power shaft.

11. A method of replacing a replaceable roller component in a two-part semiconductor substrate roller for rotating semiconductor substrates, comprising the steps of:
providing said two-part semiconductor substrate roller, which is comprised of:
a rotary power coupler; and
a first replaceable roller component attached to said rotary power coupler in a manner that permits attachment and detachment without the use of tools;
providing a second replaceable roller component;
detaching said first replaceable roller component from said rotary power coupler; and
attaching said second replaceable roller component to said rotary power coupler.

12. The method of claim 11, in which:
said rotary power coupler further comprises a threaded hole;
said first replaceable roller component further comprises a first threaded stud screwed into said threaded hole;
said second replaceable roller component further comprises a second threaded stud;
said step of detaching said first replaceable roller component further comprises unscrewing said first threaded stud from said threaded hole; and
said step of attaching said second replaceable roller component further comprises screwing said second threaded stud into said threaded hole.

13. The method of claim 11, in which:
said rotary power coupler further comprises an indented hole;
said first replaceable roller component further comprises a first set of one or more spring levers with detents inserted into said indented hole;
said second replaceable roller component further comprises a second set of one or more spring levers with detents;
said step of detaching said first replaceable roller component further comprises extracting said first set of one or more spring levers with detents from said indented hole; and
said step of attaching said second replaceable roller component further comprises inserting said second set of one or more spring levers with detents into said indented hole.

14. The method of claim 11, in which:
said rotary power coupler further comprises a first set of magnets;
said first replaceable roller component further comprises a first instance of a second set of magnets held to said first set of magnets by magnetic force;
said second replaceable roller component further comprises a second instance of said second set of magnets;
said step of detaching said first replaceable roller component further comprises pulling said replaceable roller component and said rotary power coupler apart with enough force to overcome said magnetic force; and
said step of attaching said second replaceable roller component further comprises placing said first set of magnets and said second instance of said second set of magnets in close proximity while axially aligned so that said first replaceable roller component is held to said rotary power coupler by magnetic force.

15. The method of claim 11, in which:
said rotary power coupler further comprises a hole lined with a frictional surface;
said first replaceable roller component further comprises a first stud with a frictional surface inserted into said hole;
said second replaceable roller component further comprises a second stud with a frictional surface;
said step of detaching said first replaceable roller component further comprises extracting said first stud from said hole; and
said step of attaching said second replaceable roller component further comprises inserting said second stud into said hole.

16. A method of processing a semiconductor substrate, comprising the steps of:
providing a wet chemical semiconductor substrate processing apparatus, comprising:
a tank for containing wet chemicals;
wet chemicals in said tank;
a two-part semiconductor substrate roller in said tank for rotating said semiconductor substrate, further comprising:
a rotary power coupler; and
a first replaceable roller component that attaches to said rotary power coupler in a manner that permits attachment and detachment without the use of tools;
and
a rotary power source coupled to said rotary power coupler in a manner to prevent leakage of said wet chemicals from said tank;
immersing said semiconductor substrate into said wet chemicals so that said semiconductor substrate contacts said replaceable roller component in a manner that said semiconductor substrate is rotated by said replaceable roller component;
removing said semiconductor substrate from said wet chemicals;
removing said two-part semiconductor substrate roller from said tank;
detaching said first replaceable roller component from said rotary power coupler;
providing a second replaceable roller component;
attaching said second replaceable roller component to said rotary power coupler to form a second version of said two-part semiconductor substrate roller; and
installing said second version of said two-part semiconductor substrate roller in said tank.

17. The method of claim 16, in which:
said rotary power coupler further comprises a threaded hole;
said first replaceable roller component further comprises a first threaded stud screwed into said threaded hole;
said second replaceable roller component further comprises a second threaded stud;
said step of detaching said first replaceable roller component further comprises unscrewing said first threaded stud from said threaded hole; and
said step of attaching said second replaceable roller component further comprises screwing said second threaded stud into said threaded hole.

18. The method of claim 16, in which:
said rotary power coupler further comprises an indented hole;
said first replaceable roller component further comprises a first set of one or more spring levers with detents inserted into said indented hole;
said second replaceable roller component further comprises a second set of one or more spring levers with detents;
said step of detaching said first replaceable roller component further comprises extracting said first set of one or more spring levers with detents from said indented hole; and
said step of attaching said second replaceable roller component further comprises inserting said second set of one or more spring levers with detents into said indented hole.

19. The method of claim 16, in which:
said rotary power coupler further comprises a first set of magnets;
said first replaceable roller component further comprises a first instance of a second set of magnets held to said first set of magnets by magnetic force;
said second replaceable roller component further comprises a second instance of said second set of magnets;
said step of detaching said first replaceable roller component further comprises pulling said replaceable roller component and said rotary power coupler apart with enough force to overcome said magnetic force; and
said step of attaching said second replaceable roller component further comprises placing said first set of magnets and said second instance of said second set of magnets in close proximity while axially aligned so that said first replaceable roller component is held to said rotary power coupler by magnetic force.

20. The method of claim 16, in which:
said rotary power coupler further comprises a hole lined with a frictional surface;
said first replaceable roller component further comprises a first stud with a frictional surface inserted into said hole;
said second replaceable roller component further comprises a second stud with a frictional surface;
said step of detaching said first replaceable roller component further comprises extracting said first stud from said hole; and
said step of attaching said second replaceable roller component further comprises inserting said second stud into said hole.
